(19) United States
(12) Patent Application Publication
(10) Pub. No.: US 2026/0319321 A1
(43) Pub. Date: Oct. 15, 2026

(54) ELECTRONIC PAPER DISPLAY DEVICE AND METHOD OF FABRICATING THE SAME

(71) Applicant: E Ink Holdings Inc., Hsinchu (TW)

(72) Inventors: Ian French, Hsinchu (TW); Yi Jiun Wu, Hsinchu (TW); Kuo-Hsing Cheng, Hsinchu (TW)

(73) Assignee: E Ink Holdings Inc., Hsinchu (TW)

(21) Appl. No.: 19/641,543

(22) Filed: Apr. 8, 2026

(30) Foreign Application Priority Data
Apr. 9, 2025 (TW) 114113323
Aug. 19, 2025 (TW) 114131504

(51) Int. Cl. G02F 1/1685

(52) U.S. Cl. CPC G02F 1/1685

(57) ABSTRACT

An electronic paper display device includes a substrate, an active element array layer, an electronic paper display layer, a driving circuit board, and a printed wire. The substrate has a first surface, a second surface, and a side surface. The active element array layer is disposed on the first surface. The electronic paper display layer is adhered onto the active element array layer. The driving circuit board is disposed on the second surface. The printed wire includes a vertical portion, a first extension portion, and a second extension portion integrally formed. The vertical portion directly contacts the side surface and extends between the first and second surfaces. The first extension portion laterally extends inwardly from an end of the vertical portion and contacts the active element array layer. The second extension portion laterally extends inwardly from the other end of the vertical portion and overlaps the driving circuit board.

### CROSS-REFERENCE TO RELATED APPLICATION

This application claims the priority benefits of Taiwan application serial no. 114113323, filed on Apr. 9, 2025 and Taiwan application serial no. 114131504, filed on Aug. 19, 2025. The entirety of each of the above-mentioned patent applications is hereby incorporated by reference herein and made a part of this specification.

### BACKGROUND

### Technical Field

The disclosure relates to a display device, and more particularly to an electronic paper display device.

### DESCRIPTION OF RELATED ART

Reducing the bezel width and expanding the display area are frequently considered research and development directions for various display devices. For electronic paper display devices, driving circuit chips are often bonded to the devices through chip on glass (COG) or chip on film (COF). However, such methods may occupy the display area and may also increase the bezel width, such that narrow bezel designs cannot be easily implemented.

### SUMMARY

The disclosure provides an electronic paper display device and a method of fabricating the same, which implement a narrow bezel design.

An electronic paper display device of the disclosure includes a substrate, an active element array layer, an electronic paper display layer, a driving circuit board, and a printed wire. The substrate has a first surface, a second surface, and a side surface connected between the first surface and the second surface. The active element array layer is disposed on the first surface. The electronic paper display layer is adhered onto the active element array layer. The driving circuit board is disposed on the second surface. The printed wire includes a vertical portion, a first extension portion, and a second extension portion that are integrally formed. The vertical portion directly contacts the side surface and extends between the first surface and the second surface. The first extension portion laterally extends from an end of the vertical portion inwardly away from the side surface by a first distance and contacts the active element array layer. The second extension portion laterally extends from the other end of the vertical portion inwardly away from the side surface by a second distance and overlaps the driving circuit board. The driving circuit board electrically connects the printed wire within an area of the second extension portion.

In an embodiment of the disclosure, the second distance is greater than the first distance.

In an embodiment of the disclosure, the second distance is 2 to 5 times the first distance.

In an embodiment of the disclosure, the driving circuit board is adhered onto the second surface. The driving circuit board is located between the second extension portion and the second surface. The second extension portion directly contacts a pad of the driving circuit board. A first part of the second extension portion contacts the second surface, a second part contacts the pad of the driving circuit board, and the first part is located between the second part and the vertical portion. The second extension portion further has a third part extending along a side wall of the driving circuit board and connected between the first part and the second part. The side wall of the driving circuit board is not aligned with the side surface.

In an embodiment of the disclosure, the second extension portion is located between the driving circuit board and the second surface. The electronic paper display device further includes a conductive adhesive disposed between the second extension portion and the driving circuit board, and a pad of the driving circuit board contacts the conductive adhesive. The second extension portion directly contacts the second surface.

In an embodiment of the disclosure, a thickness of the vertical portion is greater than a thickness of the first extension portion.

In an embodiment of the disclosure, a thickness of the vertical portion is greater than a thickness of the second extension portion.

In an embodiment of the disclosure, a thickness of the printed wire is greater than 1 micrometer.

In an embodiment of the disclosure, a material of the printed wire includes a composite conductive material.

In an embodiment of the disclosure, a side wall of the driving circuit board is aligned with the side surface.

In an embodiment of the disclosure, the electronic paper display device further includes a protection material covering the printed wire, such that the printed wire is located between the protection material and the substrate.

In an embodiment of the disclosure, the electronic paper display device further includes a wire board bonded to the driving circuit board.

In an embodiment of the disclosure, the electronic paper display device further includes a protection cap disposed on the electronic paper display layer.

A method of fabricating an electronic paper display device of the disclosure includes the following steps. An active element array layer is disposed on a first surface of a substrate. The substrate has a first surface, a second surface, and a side surface connected between the first surface and the second surface. A printed wire is formed on the substrate by printing. The printed wire directly contacts the side surface of the substrate and directly contacts the active element array layer. A driving circuit board is disposed on the second surface of the substrate, such that the printed wire electrically connects the driving circuit board to the active element array layer. The printed wire overlaps and contacts the driving circuit board.

In an embodiment of the disclosure, after adhering the driving circuit board onto the second surface of the substrate, the printed wire is formed to bond the driving circuit board to the printed wire.

In an embodiment of the disclosure, the printed wire contacts a pad of the driving circuit board on a side of the driving circuit board away from the substrate.

In an embodiment of the disclosure, the method of fabricating the electronic paper display device further includes adhering a wire board onto the second surface of the substrate, and bonding the driving circuit board to the wire board. The driving circuit board is bonded to the printed wire through a conductive adhesive.

In an embodiment of the disclosure, the method of fabricating the electronic paper display device further includes adhering an electronic paper display layer onto the active element array layer.

In an embodiment of the disclosure, after the substrate is placed on the jig, the electronic paper display layer is adhered onto the active element array layer, wherein the driving circuit board is accommodated in the groove of the jig.

In an embodiment of the disclosure, the printing includes plate-making printing or inkjet printing.

In an embodiment of the disclosure, a material of the printed wire includes a composite conductive material.

Based on the above, the electronic paper display device of the embodiments of the disclosure connects the active element array layer and the driving circuit board located on two opposite surfaces of the substrate by the printed wire disposed along the substrate, thereby achieving a narrow bezel design.

### BRIEF DESCRIPTION OF THE DRAWINGS

FIGS. 1A to 1E are cross-sectional structures of an electronic paper display device during a fabricating process according to an embodiment of the disclosure.

FIGS. 2A to 2C are respectively schematic top views of the structures of FIGS. 1A to 1C .

FIGS. 3A to 3D are cross-sectional structures of an electronic paper display device during a fabricating process according to an embodiment of the disclosure.

FIGS. 4A and 4B are respectively schematic top views of the structures of FIGS. 3A and 3B .

### DESCRIPTION OF THE EMBODIMENTS

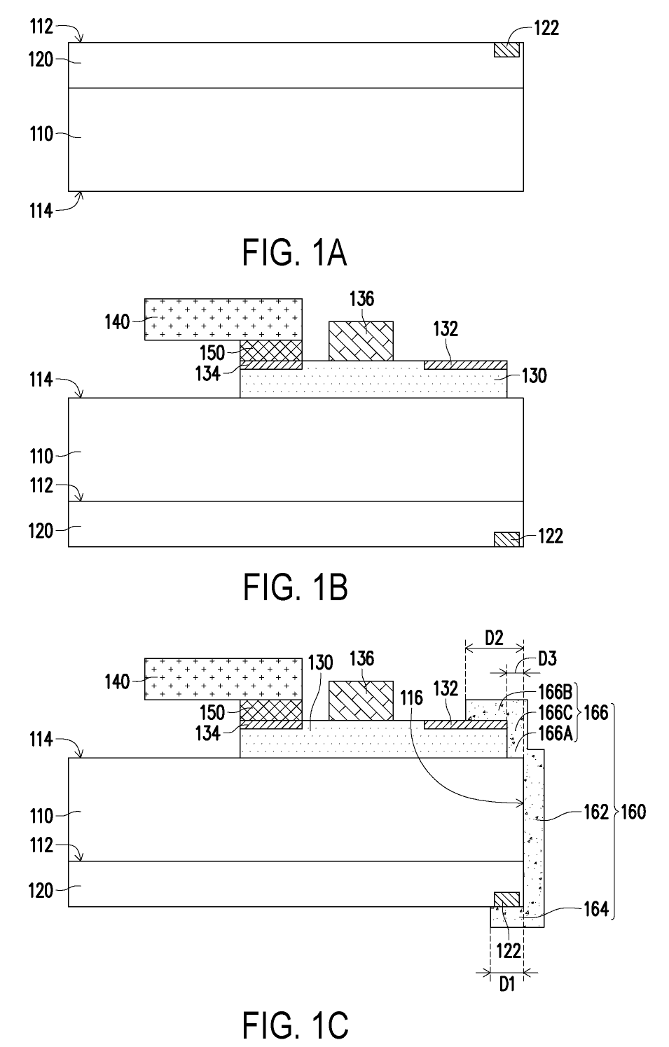

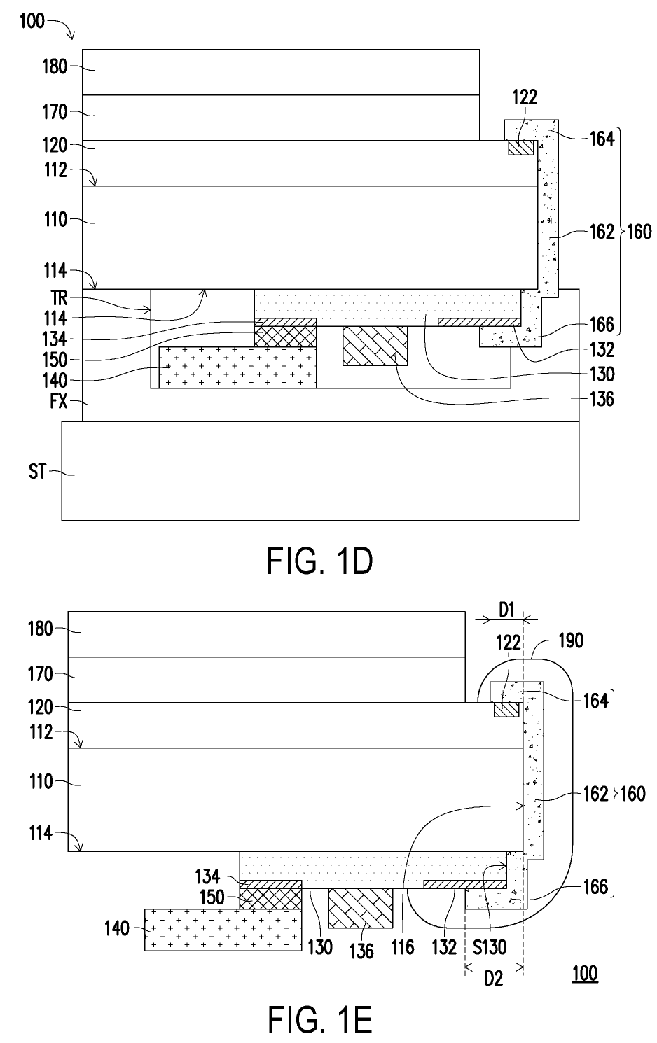

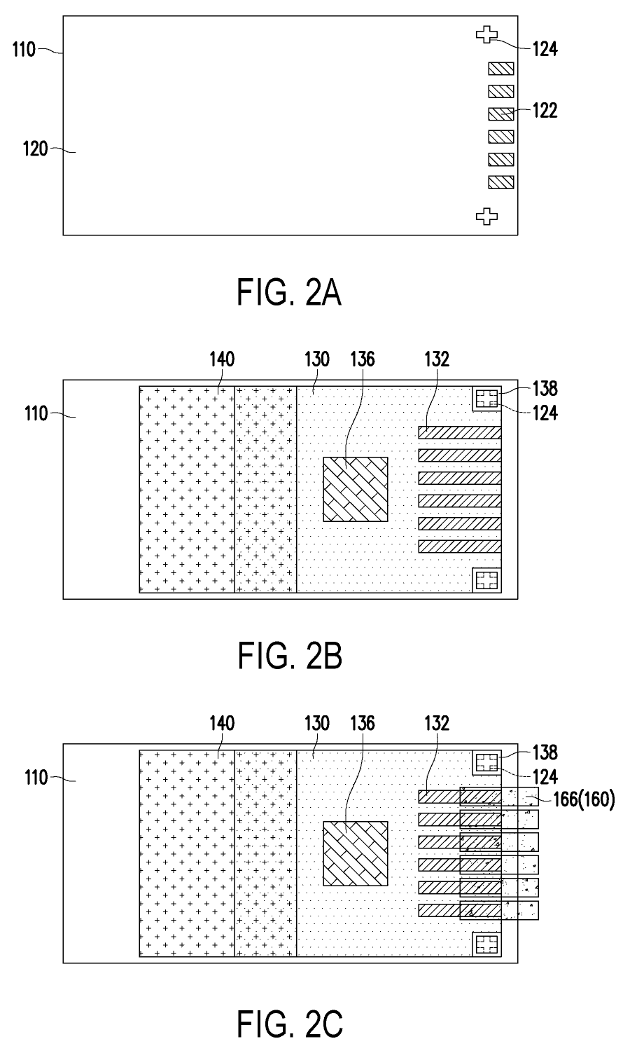

FIGS. 1A to 1E are cross-sectional structures of an electronic paper display device during a fabricating process according to an embodiment of the disclosure. FIGS. 2A to 2C are respectively schematic top views of the structures of FIGS. 1A to 1C . Please refer to FIGS. 1A and 2A . A substrate 110 is provided, and the substrate 110 has a first surface 112, a second surface 114, and a side surface 116. The first surface 112 and the second surface 114 are opposite to each other, and the side surface 116 is connected between the first surface 112 and the second surface 114. In some embodiments, the side surface 116 may be a surface parallel to the thickness direction of the substrate 110, and normal lines of the first surface 112 and the second surface 114 may be substantially parallel to the thickness direction of the substrate 110.

In addition, in FIG. 1A and FIG. 2A, the active element array layer 120 is disposed on the first surface 112. The active element array layer 120 includes a pad 122 and an alignment marker 124 disposed at the periphery. In some embodiments, the active element array layer 120 may include multiple conductive pattern layers, at least one semiconductor material layer, and multiple insulating layers, wherein the conductive pattern layer and the semiconductor material layer may form scan lines, data lines, active elements (for example, thin film transistors), capacitor structures, power lines, and other components for implementing pixel structures. The pad 122 may be connected to the scan lines, the data lines, the power lines, and other wires to transmit signals to the components. In some embodiments, the pad 122 may be formed of a conductive pattern exposed on the surface, and a material thereof may include a transparent conductive material, metal, etc.

The active element array layer 120 may be fabricated on the first surface 112 through thin film deposition, lithographic etching, etc., and the second surface 114 of the substrate 110 is a blank surface. In other words, there is no film layer, pattern, or structure fabricated through thin film deposition, lithographic etching, etc. on the second surface 114. Therefore, the substrate 110 provided with the active element array layer 120 may be a single-sided active element array substrate.

Next, a driving circuit board 130 is adhered onto the second surface 114 of the substrate 110 after turning the structure of FIG. 1A upside down to obtain the structures of FIGS. 1B and 2B . As shown in FIGS. 1 and 2B , the driving circuit board 130 has a pad 132, a pad 134, and a driving circuit chip 136. The driving circuit chip 136 may be located on a side of the driving circuit board 130 away from the second surface 114, and the pad 132 and the pad 134 are exposed on a side of the driving circuit board 130 away from the second surface 114. In other words, a back surface (the surface without any pad exposed) of the driving circuit board 130 is adhered onto the second surface 114 of the substrate 110. A wire board 140 may be further bonded to the driving circuit board 130. Specifically, the wire board 140 may be bonded to the pad 134 of the driving circuit board 130 through a conductive adhesive 150. As shown in FIG. 2B, the driving circuit board 130 may further include an alignment marker 138, and the driving circuit board 130 may be positioned through aligning the alignment marker 138 with the alignment marker 124 on the substrate 110 when the driving circuit board 130 is adhered onto the second surface 114 of the substrate 110.

In the structure of FIG. 1B, the pad 122 of the active element array layer 120 and the pad 132 of the driving circuit board 130 are exposed on two opposite sides. Next, a printed wire 160 may be formed on the structure of FIG. 1B to obtain the structures of FIGS. 1C and 2C . The printed wire 160 includes a vertical portion 162, a first extension portion 164, and a second extension portion 166 that are integrally formed. The vertical portion 162 directly contacts the side surface 116 of the substrate 110 and extends between the first surface 112 and the second surface 114. The first extension portion 164 laterally extends from an end of the vertical portion 162 inwardly away from the side surface 116 by a first distance D1 and contacts the active element array layer 120. The second extension portion 166 laterally extends from the other end of the vertical portion 162 inwardly away from the side surface 116 by a second distance D2 and overlaps the driving circuit board 130. In some embodiments, the second distance D2 may be greater than the first distance D1. In some embodiments, the second distance D2 may be 2 to 5 times the first distance D1. In some embodiments, the first distance D1 may be no greater than 100 micrometers.

In the embodiment, the first extension portion 164 of the printed wire 160 may directly contact the pad 122 of the active element array layer 120, and the second extension portion 166 of the printed wire 160 may directly contact the pad 132 of the driving circuit board 130. In this way, the driving circuit board 130 may be electrically connected to the printed wire 160 within an area of the second extension portion 166 and electrically connected to the active element array layer 120 within an area of the first extension portion 164.

The driving circuit board 130 is located between the second extension portion 166 and the second surface 114 of the substrate 110. A side wall S130 of the driving circuit board 130 may not be aligned with the side surface 116 of the substrate 110. For example, the side wall S130 of the driving circuit board 130 is spaced apart from the side surface 116 of the substrate 110 by a third distance D3 in the lateral direction. In some embodiments, the third distance D3 may be 100 micrometers or less, but not limited thereto. A first part 166A of the second extension portion 166 may contact the second surface 114, a second part 166B of the second extension portion 166 may contact the pad 132 of the driving circuit board 130, and the first part 166A is located between the second part 166B and the vertical portion 162. In addition, the second extension portion 166 further has a third part 166C. The third part 166C extends along the side wall S130 of the driving circuit board 130 and is connected between the first part 166A and the second part 166B.

The printed wire 160 may be fabricated on the substrate 110 using plate-making printing, inkjet printing, etc., but not limited thereto. The thickness of the printed wire 160 may be greater than 1 micrometer. In some embodiments, the thickness of the vertical portion 162 may be greater than the thickness of the first extension portion 164. In some embodiments, the thickness of the vertical portion 162 may be greater than the thickness of the second extension portion 166. In some embodiments, the thickness of the vertical portion 162 may be greater than the thickness of the first extension portion 164 and greater than the thickness of the second extension portion 166. In some embodiments, the material of the printed wire 160 includes a composite conductive material, such as a composite material formed by mixing metal particles and a polymer material. In other words, the material of the printed wire 160 may be a non-pure metal material or a non-alloy material.

Thereafter, the structures of FIGS. 1C and 2C are turned upside down and placed on a jig FX of FIG. 1D, such that the active element array layer 120 faces upward. The jig FX may be placed on a workbench ST and has a groove TR. The groove TR may accommodate the driving circuit board 130 and the wire board 140 protruding from the second surface 114 of the substrate 110, so that the substrate 110 is oriented on a horizontal plane or a working plane. Next, an electronic paper display layer 170 and a protection cap 180 are sequentially adhered onto the active element array layer 120 to form the electronic paper display device 100. A display material in the electronic paper display layer 170 may optionally include a microcapsule display material, an electrophoretic display material, an electrowetting display material, etc.

In FIG. 1E, a protection material 190 may be further optionally disposed on the substrate 110. The protection material 190 may cover the printed wire 160, so that the printed wire 160 is located between the protection material 190 and the substrate 110. In some embodiments, the protection material 190 may be optionally disposed at the periphery of the substrate 110 before the substrate 110 is placed on the jig FX of FIG. 1D, but not limited thereto.

In FIG. 1E, the electronic paper display device 100 may at least include a substrate 110, an active element array layer 120, an electronic paper display layer 170, a driving circuit board 130, and a printed wire 160. The substrate 110 is, for example, a glass substrate and has a first surface 112, a second surface 114, and a side surface 116 connected between the first surface 112 and the second surface 114. The active element array layer 120 is disposed on the first surface 112. The electronic paper display layer 170 is adhered onto the active element array layer 120 and is driven by a pixel structure in the active element array layer 120 to provide a display function. The driving circuit board 130 is disposed on the second surface 114. The printed wire 160 is disposed along the side surface 116 of the substrate 110. The active element array layer 120 may include various signal lines, such as scan lines, data lines, power lines, etc., and the printed wire 160 is configured to electrically connect the driving circuit board 130 to the active element array layer 120.

The printed wire 160 may specifically include a vertical portion 162, a first extension portion 164, and a second extension portion 166 that are integrally formed. The vertical portion 162 directly contacts the side surface 116 of the substrate 110 and extends between the first surface 112 and the second surface 114. The first extension portion 164 is laterally separated from the side surface 116 by a first distance D1 and contacts a pad 122 on the active element array layer 120. The second extension portion 166 is laterally separated from the side surface 116 by a second distance D2 and overlaps and contacts a pad 132 on the driving circuit board 130. In this way, the driving circuit board 130 is electrically connected to the printed wire 160 within an area of the second extension portion 166 without passing through other pad structures. The second distance D2 may be greater than the first distance D1 and may be, for example, 2 to 5 times the first distance D1, but not limited thereto. The first extension portion 164 extends on the first surface 112, and the first surface 112 is a side providing a display image. Therefore, an extension distance of the first extension portion 164 is reduced, which helps to achieve a narrow bezel design. The second extension portion 166 extends on a side not used for display, so the second extension portion 166 is not limited to a short extension distance. The second extension portion 166 may have an appropriate extension distance to implement a good bonding yield.

In the embodiment, a back side of the driving circuit board 130 is adhered onto the second surface 114, so that the pad 132 of the driving circuit board 130 is located on a side of the driving circuit board 130 away from the substrate 110. Meanwhile, the pad 122 of the active element array layer 120 is located on a side of the active element array layer 120 away from the substrate 110. In some embodiments, the driving circuit board 130 may be retracted relative to the side surface 116. In other embodiments, the driving circuit board 130 may be aligned with the side surface 116. When the driving circuit board 130 is retracted relative to the side surface 116, the second extension portion 166 of the printed wire 160 may be bent to be divided into three parts as shown in FIG. 1C, but not limited thereto. When the driving circuit board 130 is aligned with the side surface 116, the vertical portion 162 may continuously contact the side surface 116 of the substrate 110 and a side wall S130 of the driving circuit board 130.

In the embodiment, the driving circuit board 130 may include a driving circuit chip 136, and the driving circuit board 130 carries the driving circuit chip 136 by adopting chip on film (COF) packaging. The electronic paper display device 100 may further include a wire board 140, and the wire board 140 may be bonded to another pad 134 of the driving circuit board 130 through a conductive adhesive 150. In some embodiments, the conductive adhesive 150 may be an anisotropic conductive film (ACF), an anisotropic conductive paste (ACP), etc. According to the stacking relationship, the driving circuit board 130 is located between the wire board 140 and the substrate 110. In addition, the electronic paper display device 100 may further include a protection cap 180 disposed on the electronic paper display layer 170 and a protection material 190 covering the printed wire 160.

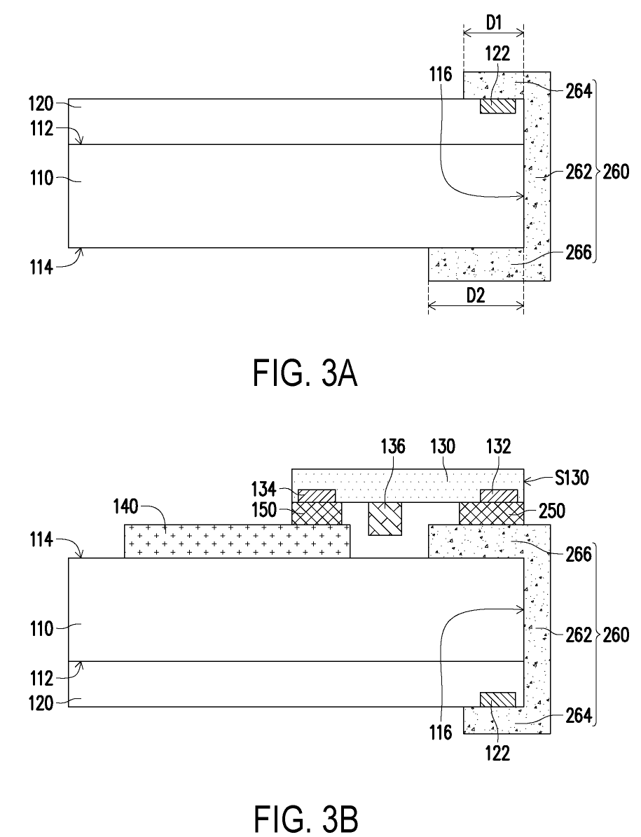

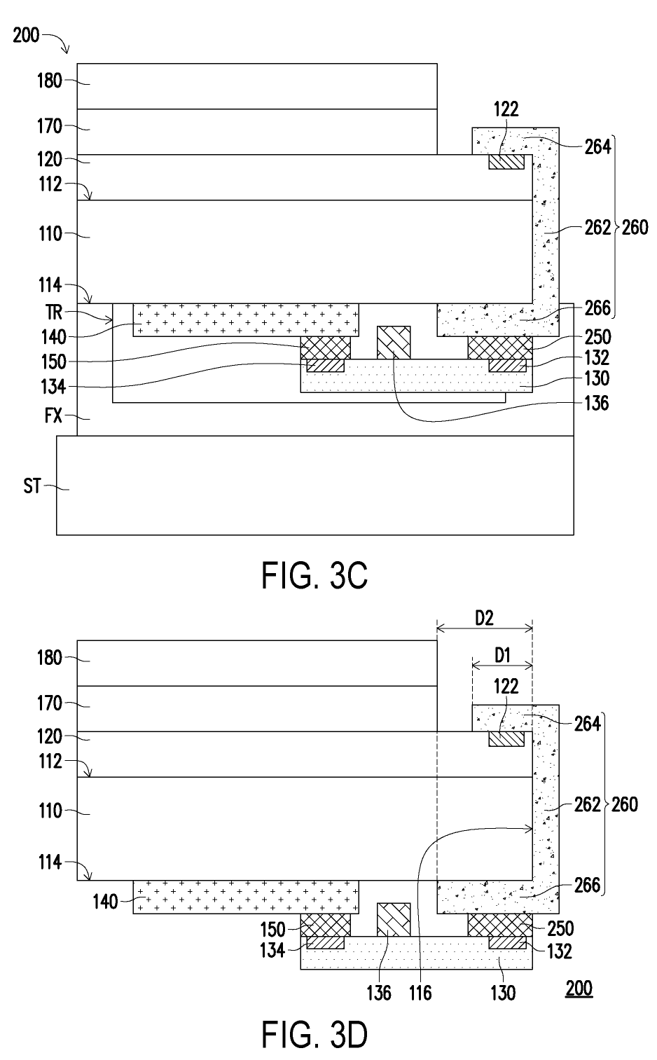

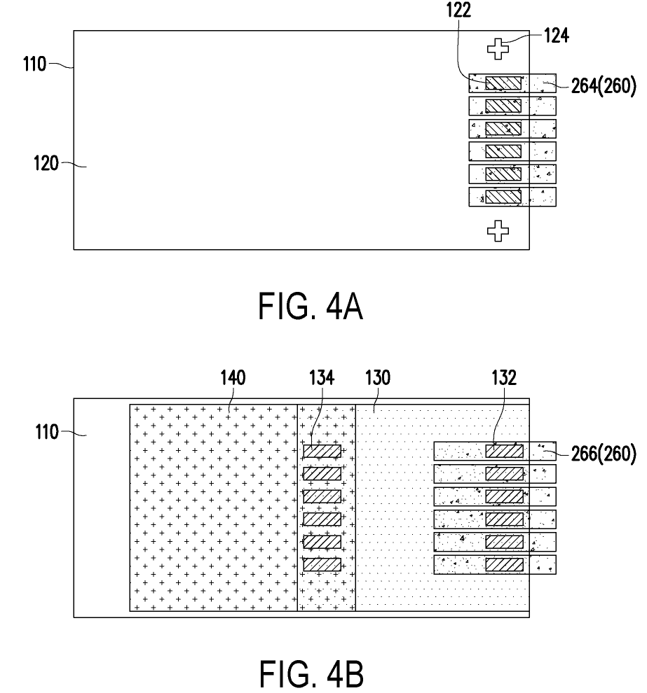

FIGS. 3A to 3D are cross-sectional structures of an electronic paper display device during a fabricating process according to an embodiment of the disclosure. FIGS. 4A and 4B are respectively schematic top views of the structures of FIGS. 3A and 3B . In the embodiment of FIGS. 3A to 3D , some components may be substantially the same as those in the embodiment of FIGS. 1A to 1E . Therefore, the same components in the two embodiments are labeled with the same reference numerals, and the description content of the components in the two embodiments may be cross-referenced and/or referred to each other.

Please refer to FIGS. 3A and 4A . A substrate 110 is provided, and the substrate 110 has a first surface 112, a second surface 114, and a side surface 116. In addition, an active element array layer 120 is disposed on the first surface 112. The active element array layer 120 includes a pad 122 and an alignment marker 124 disposed at the periphery. Reference may be made to the content of the above embodiment for the description of the substrate 110 and the active element array layer 120, which will not be repeated. Similar to the above embodiment, the substrate 110 and the active element array layer 120 form a single-sided active element array substrate, and the second surface 114 of the substrate 110 has no film layer, pattern, or structure fabricated through thin film deposition, lithographic etching, etc.

In the embodiment, a printed wire 260 is directly printed on the substrate 110. The method of fabricating the printed wire 260 may include plate-making printing and inkjet printing. Therefore, the thickness of the printed wire 260 is about 1 micrometer or even thicker. In some embodiments, the printed wire 260 may be fabricated by sputtering. The printed wire 260 includes a vertical portion 262, a first extension portion 264, and a second extension portion 266 that are integrally formed. The vertical portion 262 directly contacts the side surface 116 and extends between the first surface 112 and the second surface 114. The first extension portion 264 laterally extends from an end of the vertical portion 262 inwardly away from the side surface 116 by a first distance D1 and contacts the pad 122 of the active element array layer 120. The second extension portion 266 laterally extends from the other end of the vertical portion 262 inwardly away from the side surface 116 by a second distance D2 and entirely contacts the second surface 114. The first distance D1 may be less than the second distance D2. In some embodiments, the second distance D2 may be 2 to 5 times the first distance D1. For example, the first distance D1 may be approximately 100 micrometers or less than 100 micrometers. The first extension portion 264 extends on the first surface 112, and the first surface 112 is a side providing a display image. Therefore, an extension distance of the first extension portion 264 is reduced, which helps to achieve a narrow bezel design. The second extension portion 266 extends on a side not used for display, so an extension distance of the second extension portion 266 does not need to be limited. The second extension portion 266 may have an appropriate extension distance to implement a good bonding yield. In the embodiment, the second extension portion 266 is directly disposed along the second surface 114, so that extension paths of the vertical portion 262 and the second extension portion 266 may substantially conform to a surface contour of the substrate 110.

Next, the structures of FIGS. 3A and 4A are turned upside down, the wire board 140 is adhered onto the second surface 114 of the substrate 110, and the driving circuit board 130 is bonded to the printed wire 260 and the wire board 140, as shown in FIGS. 3B and 4B . A back surface of the wire board 140 is adhered onto the second surface 114 of the substrate 110, and the driving circuit board 130 may be bonded to the wire board 140 through a conductive adhesive 150. In addition, the driving circuit board 130 may be bonded to the printed wire 260 through a conductive adhesive 250. In some embodiments, the conductive adhesive 150 and the conductive adhesive 250 may be anisotropic conductive films (ACF), anisotropic conductive pastes (ACP), etc.

The pad 132 and the pad 134 of the driving circuit board 130 are located on a side of the driving circuit board 130 facing the substrate 110, and a driving circuit chip of the driving circuit board 130 is also located on a side close to the substrate 110. The driving circuit board 130 may be positioned through the alignment marker 124 (shown in FIG. 4A) on the substrate 110 when bonded to the printed wire 260. In some embodiments, the driving circuit board 130 may be positioned such that the side wall S130 of the driving circuit board 130 is flush with the side surface 116 of the substrate 110, but not limited thereto. In some embodiments, the driving circuit board 130 may be positioned such that the side wall S130 of the driving circuit board 130 is spaced from the side surface 116 of the substrate 110 by a lateral distance.

Thereafter, the structures of FIGS. 3B and 4B are turned upside down and placed on the jig FX of FIG. 1D, such that the active element array layer 120 faces upward. Subsequently, the electronic paper display layer 170 and the protection cap 180 are sequentially adhered onto the active element array layer 120 to form an electronic paper display device 200. The jig FX may be placed on the workbench ST and has a groove TR. The groove TR may accommodate the driving circuit board 130 and the wire board 140 protruding from the second surface 114 of the substrate 110, so that the substrate 110 is oriented on a horizontal plane or a working plane.

The electronic paper display device 200 removed from the jig FX is as shown in FIG. 3D. The electronic paper display device 200 at least includes a substrate 110, an active element array layer 120, a driving circuit board 130, and a printed wire 260. The substrate 110 has a first surface 112, a second surface 114 opposite to the first surface 112, and a side surface 116 connected between the first surface 112 and the second surface 114. The active element array layer 120 is disposed on the first surface 112 of the substrate 110, and the driving circuit board 130 is disposed on the second surface 114 of the substrate 110. Therefore, the active element array layer 120 and the driving circuit board 130 are located on two opposite sides of the substrate 110 and are separated by the substrate 110. The printed wire 260 is continuously disposed along the first surface 112, the side surface 116, and the second surface 114 to electrically connect the active element array layer 120 and the driving circuit board 130.

Specifically, the printed wire 260 includes a vertical portion 262 and a first extension portion 264 that are integrally formed. The vertical portion 262 directly contacts the side surface 116 and extends between the first surface 112 and the second surface 114. The first extension portion 264 inwardly extends from the vertical portion 262 at an end of the first surface 112 along the first surface 112 by a first distance D1 to at least contact the pad 122 of the active element array layer 120. In some embodiments, the first extension portion 264 may extend beyond the pad 122 to entirely cover the pad 122, but not limited thereto. The first surface 112 is located on a display side providing a display image of the electronic paper display device 200, and an inward extension length (the first distance D1) of the first extension portion 264 may be, for example, no greater than 100 micrometers, which helps to reduce an area occupied by a non-displayable region at the periphery of the display side, so as to achieve a narrow bezel design.

The printed wire 260 further includes a second extension portion 266 integrally formed with the vertical portion 262. The second extension portion 266 inwardly extends from the vertical portion 262 at an end of the second surface 114 along the second surface 114 by a second distance D2. The second surface 114 is located at a back side of the electronic paper display device 200, so an extension length of the second extension portion 266 does not affect the display area of the electronic paper display device 200. In some embodiments, an inward extension length of the second extension portion 266 may be greater than the inward extension length of the first extension portion 264, that is, the second distance D2 may be greater than the first distance D1. In some embodiments, the second distance D2 may be 2 to 5 times the first distance D1. In some embodiments, the inward extension length (the second distance D2) of the second extension portion 266 may be determined by the method of fabricating the printed wire 260. For example, when the printed wire 260 is fabricated by plate-making printing, the second distance D2 may be determined by the process capability of a printing jig.

The driving circuit board 130 may be bonded to the second extension portion 266 of the printed wire 260 through the conductive adhesive 250. The configuration position of the driving circuit board 130 may be adjusted according to the inward extension length (the second distance D2) of the second extension portion 266. In some embodiments, the driving circuit board 130 may be configured such that a side wall of the driving circuit board 130 is flush with the side surface 116 of the substrate 110. In some embodiments, the driving circuit board 130 may be configured such that the side wall of the driving circuit board 130 is retracted relative to the side surface 116 of the substrate 110 by a distance.

The electronic paper display device 200 further includes an electronic paper display layer 170 adhered onto the active element array layer 120. The area of the electronic paper display layer 170 may determine the display area of the electronic paper display device 200. The smaller the inward extension length (the first distance D1) of the first extension portion 264, the larger the area occupied by the electronic paper display layer 170 on the first surface 112, which helps to achieve a narrow bezel design. In some embodiments, the inward extension length (the first distance D1) of the first extension portion 264 enables the first extension portion 264 to be located outside the electronic paper display layer 170, and the inward extension length (the second distance D2) of the second extension portion 266 enables the second extension portion 266 to overlap the area of the electronic paper display layer 170. In some embodiments, the extension lengths of the first extension portion 264 and the second extension portion 266 may be such that neither the first extension portion 264 nor the second extension portion 266 overlaps the electronic paper display layer 170. In addition, the electronic paper display device 200 further includes a wire board 140 and a protection cap 180, and reference may be made to the above embodiment for the related description thereof.

In the above embodiments, the driving circuit board 130 and the electronic paper display layer 170 are located on two opposite sides of the substrate 110, and a driving signal provided by the driving circuit board 130 may be transmitted to the active element array layer 120 through the printed wire 160 or the printed wire 260 with a three-dimensional structure disposed along the contour of the substrate 110. The printed wire 160 or the printed wire 260 occupies a small area (for example, the first distance D1 is no greater than 100 micrometers) on the first surface 112 provided with the electronic paper display layer 170, thereby achieving a narrow bezel design. The driving circuit board 130 may be directly bonded to the printed wire 160 or the printed wire 260 extending on the second surface 114 (the back side of the device). Therefore, the second surface 114 of the substrate 110 does not need to be provided with a film layer, a pattern, or a structure fabricated by thin film deposition, lithographic etching, etc., which helps to simplify the fabrication of the substrate 110. During the actual manufacturing production, it is also easier to obtain the substrate 110 with a film layer, a pattern, or a structure fabricated by thin film deposition, lithographic etching, etc. formed on only one side. Therefore, the electronic paper display device 100 or the electronic paper display device 200 may be fabricated at a lower manufacturing cost.

In summary, the electronic paper display device of the embodiments of the disclosure implements signal transmission on opposite sides of the substrate by the printed wire, so as to implement a narrow bezel design with low fabricating cost and simple fabrication.

What is claimed is:

1. An electronic paper display device, comprising:
a substrate, having a first surface, a second surface, and a side surface connected between the first surface and the second surface;
an active element array layer, disposed on the first surface;
an electronic paper display layer, adhered onto the active element array layer;
a driving circuit board, disposed on the second surface; and
a printed wire, comprising a vertical portion, a first extension portion, and a second extension portion that are integrally formed, wherein the vertical portion directly contacts the side surface and extends between the first surface and the second surface, the first extension portion laterally extends from an end of the vertical portion inwardly away from the side surface by a first distance and contacts the active element array layer, and the second extension portion laterally extends from other end of the vertical portion inwardly away from the side surface by a second distance and overlaps the driving circuit board, wherein the driving circuit board is electrically connected to the printed wire within an area of the second extension portion.

2. The electronic paper display device according to claim 1, wherein the second distance is greater than the first distance.

3. The electronic paper display device according to claim 1, wherein the second distance is 2 to 5 times the first distance.

4. The electronic paper display device according to claim 1, wherein the driving circuit board is adhered onto the second surface.

5. The electronic paper display device according to claim 4, wherein the driving circuit board is located between the second extension portion and the second surface.

6. The electronic paper display device according to claim 4, wherein the second extension portion directly contacts a pad of the driving circuit board.

7. The electronic paper display device according to claim 4, wherein a first part of the second extension portion contacts the second surface, a second part of the second extension portion contacts a pad of the driving circuit board, and the first part is located between the second part and the vertical portion.

8. The electronic paper display device according to claim 7, wherein the second extension portion further has a third part extending along a side wall of the driving circuit board and connected between the first part and the second part.

9. The electronic paper display device according to claim 7, wherein a side wall of the driving circuit board is not aligned with the side surface.

10. The electronic paper display device according to claim 1, wherein the second extension portion is located between the driving circuit board and the second surface.

11. The electronic paper display device according to claim 10, further comprising a conductive adhesive disposed between the second extension portion and the driving circuit board, wherein a pad of the driving circuit board contacts the conductive adhesive.

12. The electronic paper display device according to claim 10, wherein the second extension portion directly contacts the second surface.

13. The electronic paper display device according to claim 1, wherein a thickness of the vertical portion is greater than a thickness of the first extension portion.

14. The electronic paper display device according to claim 1, wherein a thickness of the vertical portion is greater than a thickness of the second extension portion.

15. The electronic paper display device according to claim 1, wherein a thickness of the printed wire is greater than 1 micrometer.

16. The electronic paper display device according to claim 1, wherein a material of the printed wire comprises a composite conductive material.

17. The electronic paper display device according to claim 1, wherein a side wall of the driving circuit board is aligned with the side surface.

18. The electronic paper display device according to claim 1, further comprising a protection material covering the printed wire, such that the printed wire is located between the protection material and the substrate.

19. The electronic paper display device according to claim 1, further comprising a wire board bonded to the driving circuit board.

20. The electronic paper display device according to claim 1, further comprising a protection cap disposed on the electronic paper display layer.

21. A method of fabricating an electronic paper display device, comprising:
disposing an active element array layer on a first surface of a substrate, wherein the substrate has the first surface, a second surface, and a side surface connected between the first surface and the second surface;
forming a printed wire on the substrate by printing, wherein the printed wire directly contacts the side surface of the substrate and directly contacts the active element array layer; and
disposing a driving circuit board on the second surface of the substrate, such that the printed wire electrically connects the driving circuit board to the active element array layer, wherein the printed wire overlaps and contacts the driving circuit board.

22. The method of fabricating the electronic paper display device according to claim 21, wherein after adhering the driving circuit board onto the second surface of the substrate, the printed wire is formed to bond the driving circuit board to the printed wire.

23. The method of fabricating the electronic paper display device according to claim 21, wherein the printed wire contacts a pad of the driving circuit board on a side of the driving circuit board away from the substrate.

24. The method of fabricating the electronic paper display device according to claim 21, further comprising adhering a wire board onto the second surface of the substrate, and bonding the driving circuit board to the wire board.

25. The method of fabricating the electronic paper display device according to claim 21, further comprising adhering an electronic paper display layer onto the active element array layer.

26. The method of fabricating the electronic paper display device according to claim 21, wherein the printing comprises plate-making printing or inkjet printing.

27. The method of fabricating the electronic paper display device according to claim 21, wherein a material of the printed wire comprises a composite conductive material.
